(19) United States
(12) Patent Application Publication
(10) Pub. No.: US 2018/0264766 A1
(43) Pub. Date: Sep. 20, 2018

(54) CONTACT AND NON-CONTACT SUBSTRATE PROCESSING

(71) Applicant: HP SCITEX LTD., Netanya (IL)

(72) Inventor: Alex Veis, Kadima (IL)

(73) Assignee: HP SCITEX LTD., Netanya (IL)

(21) Appl. No.: 15/915,833

(22) Filed: Mar. 8, 2018

(30) Foreign Application Priority Data
Mar. 15, 2017 (EP) 17161207.0

(51) Int. Cl. B31B 50/20; B31B 50/25; B31B 50/00

(52) U.S. Cl. CPC B31B 50/20; B31B 50/25; B31B 2120/302; B31B 50/005; B31B 50/006

(57) ABSTRACT

Devices and methods to process substrates are disclosed. The proposed devices comprise contact and non-contact processing modules and a controller. The controller identifies straight and curved lines to be processed on the substrate and displaces the contact processing modules relative to the substrate to process the straight lines and the non-contact processing modules relative to the substrate to process the curved lines.

### BACKGROUND

Printing and packaging substrate materials, such as paper, cardboard or carton are processed to cut and/or to score the substrate with folding lines, depending on the printing and packaging material to be produced. A substrate processing or cutting machine is applied to cut and shape the printing and packaging material, whereas the substrate may also be scored with folding lines if the printing and packaging material is to be folded by a user.

### BRIEF DESCRIPTION

Some non-limiting examples of the present disclosure are described in the following with reference to the appended drawings, in which:

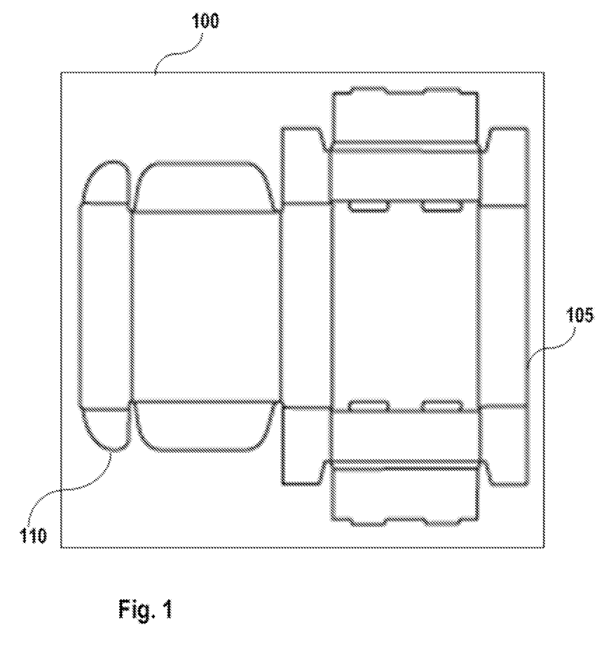

FIG. 1 schematically illustrates a substrate where processing lines have been indicated.

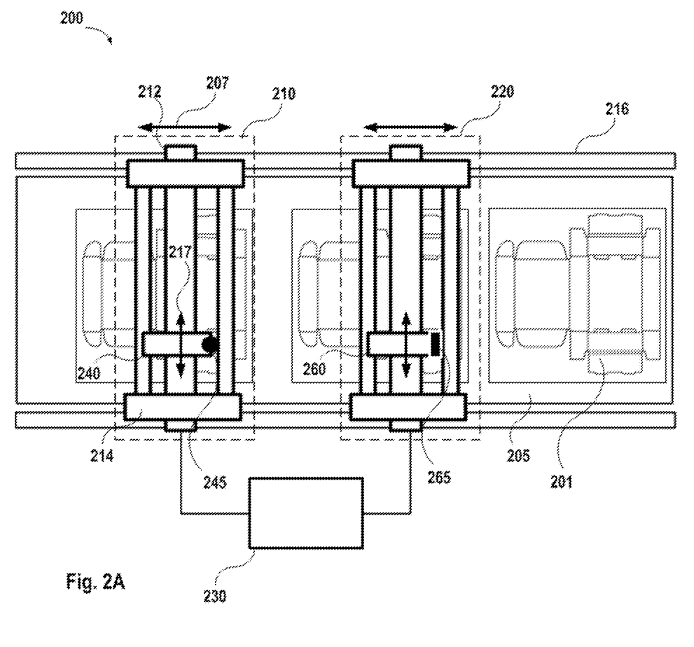

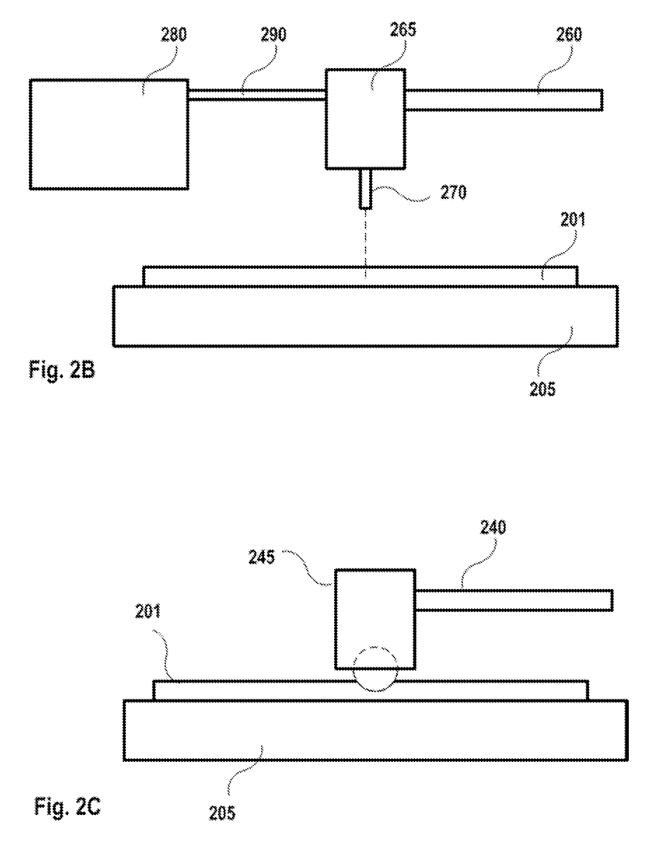

FIG. 2A schematically illustrates a top view of a device to process a substrate, according to an example.

FIG. 2B schematically illustrates a wheel-type cutter supported by a holding unit.

FIG. 2C schematically illustrates a jet nozzle supported by a holding unit.

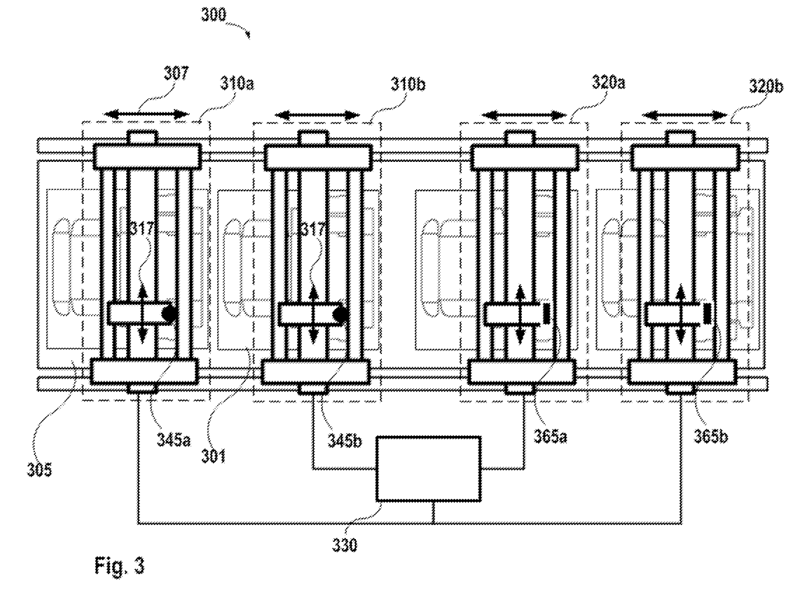

FIG. 3 schematically illustrates a top view of a device to process a substrate, according to another example.

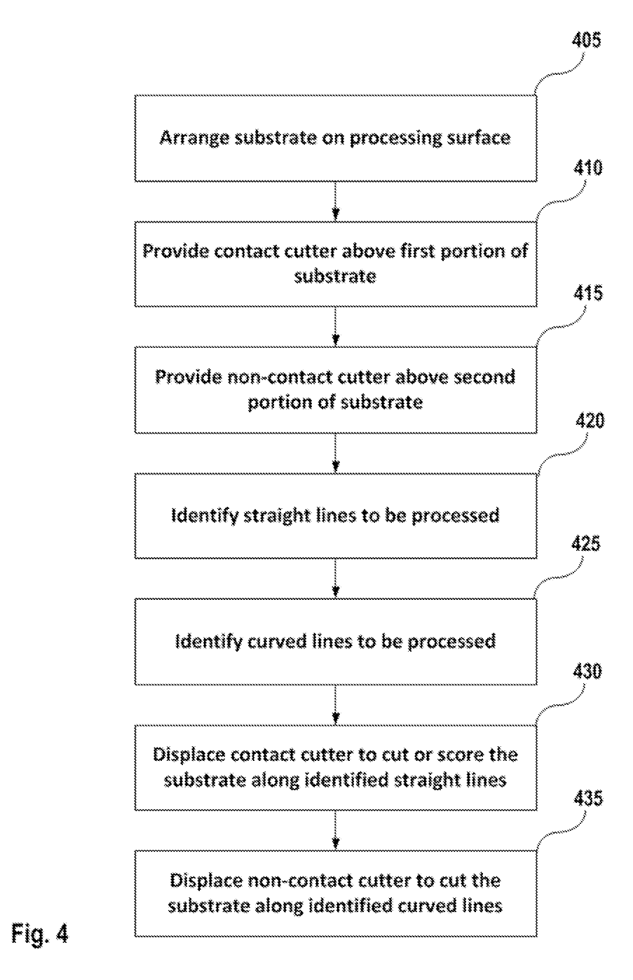

FIG. 4 is a flow diagram of a method of processing a substrate according to an example.

### DETAILED DESCRIPTION

One category of substrate processing machine is a contact processing machine. The term “contact processing” is used hereinafter to denote processes or machines where a mechanical part of the process or machine comes in contact with the substrate. A contact processing machine may comprise one or more mechanical cutters using cutting blades. Such mechanical cutters may have a body including and supporting a cutting edge, wherein the body is made to withstand the respective cutting forces. Hence, the physical dimensions of mechanical cutting blades may generally depend on the processing speed and the thickness and material properties of the substrate being cut. For thicker or tiled corrugated cardboards generally stronger and thus larger mechanical cutting blades may be used compared to the cutting blades used for thinner and single layered corrugated cardboards. Wheel type roller cutters (sometimes referred to herein as “wheel type cutters” or “pizza type cutters”) are a type of mechanical cutters and comprise a circular body having a cutting edge provided along the circumference of the circular body. The circular body is rotatable about an axis such as to be rolled through the substrate being cut. These types of mechanical cutting blades withstand and convey forces to the cutting edge. However, the mechanical cutting blades are adapted to roll along the cutting edge in a straight direction and are thus generally suitable for cutting straight or slightly curved lines. Pizza type cutters may not be suited for cutting curved and/or edged outlines of substrates such as corrugated cardboard boxes that may be designed to be rigid. Cutting such substrates using cutters with knives may imply relatively high forces and extended knife lifetimes, thus raising the associated system and operational costs.

FIG. 1 schematically illustrates a substrate where processing (cutting and scoring) lines have been indicated. Substrate 100 may comprise after cutting straight lines 105 and curved lines 110. Cutting such a shape using a pizza type cutter may not be possible due to the curves and edges involved in the cutting design. Other mechanical cutting systems with narrow knives cutting in three dimensions (XYZ) and also configured to perform cuts at an angle (θ type cutter) may be employed. Even so, in case of thicker cardboards, cutting relatively small curves may not be possible.

A non-contact substrate processing machine may be used when the thickness of the substrate and/or the shape of the cutting line may not be suitable for mechanical cutters. The term “non-contact processing” is used hereinafter to denote processes and machines where no mechanical cutting part may be in contact with the substrate. Non-contact substrate processing systems, such as for example laser cutting systems, high pressure water jet cutters or liquefied gas cutting systems (e.g. liquefied nitrogen cutting systems) may cut cardboards or cartons without contacting mechanically the substrate and without rotating a cutting edge of a cutting blade for applying lateral cutting forces on the substrate. Non-contact substrate processing systems may direct a laser beam, a water jet or a liquefied gas stream substantially perpendicularly to the cutting surface of the substrate and thus cut cutting lines into the paper, cardboard or carton. Thus, the laser beam, the liquid water jet or liquefied gas stream may be directed in a flexible and adjustable manner to follow complicated patterns of cutting lines, including edges and sharp curves.

Laser cutting systems typically employ high power lasers, with comparatively high laser maintenance costs and may not keep the laser in focus when cutting through relatively thick boards. High pressure water jet cutters may cut a wide variety of materials from paper to steel at comparatively high speeds. However, for packaging substrates, such as paper, cardboard or carton, they may not be suitable as they may wet the boards. The liquefied gas cutters, such as liquefied nitrogen cutters may be relatively slow because their speed depends on the liquefied gas production capabilities (a higher speed generally uses more gas).

Liquefied gas or jet cutters may cut substrates up to 30 mm thick. However, although they may perform precision cuts (e.g. cuts around curves and edges or small holes) with accuracy, they are comparatively slow for straight lines when compared with contact (mechanical) cutters.

FIG. 2A schematically illustrates a top view of a device to process a substrate, according to an example. Device 200 comprises a contact substrate processing module 210, a non-contact substrate processing module 220 and a controller 230. The contact processing module may comprise a mechanical wheel-type cutter. The non-contact substrate processing module may be a high-pressure liquefied nitrogen cutter. The controller 230 may control the movement of the contact processing module 210 and the movement of the non-contact processing module 220. The controller 230 may further identify straight and curved lines to be processed on the substrate. Thus, the controller may displace the mechanical processing module 210 relative to the substrate to process the straight lines and displace the liquid jet processing module 220 relative to the substrate to process the curved lines.

During operation, one or more substrates 201 may be arranged on a platform 205. The controller 230 may identify straight lines and curved lines on the substrates to be cut or scored. Then the controller may provide coordinates of the straight and/or curved lines to the processing modules. More specifically, the controller may provide coordinates for the straight lines to the mechanical (contact) processing module 210 and coordinates for the curved lines to the liquefied nitrogen (non-contact) processing module 220. The modules 210 and 220 may be displaceable along an axis 207, e.g. a horizontal axis. Each of the modules 210, 220 may comprise a holding unit 240, 260, respectively. Each holding unit may comprise a slider 212, displaceable along a second axis 217. The slider 212 may be mounted on bridges 214. The bridges 214 may be sliding on rails 216. The holding unit 240 may support a wheel-type cutter 245. FIG. 2B schematically illustrates a wheel-type cutter 245 supported by holding unit 240. The wheel-type cutter 245 may comprise mechanical cutting blades 247 comprising a circular body having a cutting edge provided along the circumference of the circular body. The circular body may be rotatable about an axis such as to be rolled through the substrate 201 being cut. Accordingly, the holding unit 260 may support one or more jet nozzles 270 and a fluid container 280 as illustrated in FIG. 2C. In this example, the fluid container 280 may contain liquid nitrogen and may be connected to the jet nozzle 270 via a fluid conductor 290 such as for example a pipe, tube, or hose that may convey the liquid nitrogen from the fluid container 280 to the jet nozzle 270. The fluid container 280 and fluid conductor 290 may provide the jet nozzle 270 with liquid nitrogen having sufficient pressure for the jet nozzle 270 to direct a jet stream of liquid nitrogen to the sheet of paper, cardboard or carton 201. For this purpose, for example the fluid container 280 or fluid conductor 290 may include pumps, valves, or other devices to provide the jet nozzle 270 with liquid nitrogen under pressure. In this way, the jet nozzle 270 may provide a directed jet stream of liquid nitrogen for cutting the at least one sheet of paper, cardboard or carton 201. Lower pressures may be applied to score folding lines into the substrate 201. The jet nozzle 270 may have different shapes and dimensions and may be arranged at different distances from the at least one sheet of paper, cardboard or carton 201. In the example illustrated in FIG. 2C, the jet nozzle 270 may be arranged at a distance of approximately 0.5 to 2 cm from the surface of the substrate 201, and the orifice of the jet nozzle 270 may have a diameter of about 0.01 to 0.04 cm, although other dimensions of the orifice and distance to the surface may apply in accordance with the present disclosure. For example, the respective distance from the surface of the substrate 201 and the dimensions of the orifice of the jet nozzle 270 may depend on the pressure of the liquid nitrogen at the jet nozzle 270 and on the thickness and material characteristics of the substrate 201 being cut.

As the bridge 212 moves along axis 207, the wheel-type cutter may e.g. cut or score lines along a horizontal direction. For vertical lines, the bridge 214 may remain stationary and the holding unit 240 may be displaced along the vertical axis 217. For oblique or diagonal lines, both the bridge 212 and the holding unit 240 may move at the same time. Accordingly, for the curved lines, the holding unit 260 may move as the bridge of the liquid jet processing module 220 is moving along axis 207.

FIG. 3 shows a top view of a device to process a substrate, according to another example. The device 300 shown in FIG. 3 may comprise multiple (“n” number of) non-contact cutters (e.g. with jet nozzles of a liquefied nitrogen cutter) that may run in parallel and multiple (“k” number of) wheel-type cutters that may also run in parallel to increase the system throughput. In the example of FIG. 3, n=2 and k=2. However, any number of liquid jet cutters and wheel-type cutters may be used. The wheel-type cutters may cut straight lines. For example the wheel cutter 345a of mechanical cutter 310a may be used to cut horizontal straight lines whereas the wheel-type cutter 345b of mechanical cutter module 310b may be used to cut vertical lines. Alternatively or additionally, one mechanical cutter may cut lines in a first portion of a substrate while another cutter may cut lines at another portion of the substrate. Thus the overall speed may be increased. In another case, one mechanical cutter may be used for cutting and another for scoring to produce folding lines. The non-contact cutters 365a and 365b of non-contact processing modules 320a, 320b, respectively may be used to cut different types of curves or edges or different areas of the substrate. The controller may calculate the time a contact cutter may take to cut the straight lines and the time a non-contact cutter may take to cut the curved lines or edges. By comparing the times, it may employ more cutters of one or of another type to optimize the overall speed and avoid dead times. For example, in a multi-cutter system if straight lines may be cut by one contact cutter on an average of K seconds and curved lines by one non-contact cutter on an average of N seconds, the overall speed may be optimized by using the least common multiple (LCM) of (K, N). By using LCM/K number of contact cutters and LCM/N number of non-contact numbers to distribute the work dead time may be minimized.

By combining non-contact cutters, such as liquefied gas (e.g. nitrogen) jet cutters and contact cutters, such as wheel-type cutters, precision may be maintained without sacrificing speed. This is because the majority of cutting actions performed on a packaging substrate involves straight lines. Thus the straight lines may be cut or scored with the speed of the mechanical contact wheel-type cutter whereas the edges and curved lines may be cut with the accuracy and precision of the non-contact cutter.

The wheel-type cutters may cut straight and large diameter lines, while the non-contact cutters may cut all residual lines that wheel-type cutters may not cut.

FIG. 4 is a flow diagram of a method of processing a substrate according to an example. In block 405, a substrate may be arranged on a processing surface. The substrate may be paper, cardboard or carton. In block 410 a mechanical cutter may be provided above a first portion of the substrate. In block 415 a liquid jet cutter may be provided above a second portion of the substrate. In block 420, one or more straight lines may be identified to be processed (cut or scored) by the mechanical cutter on the substrate. In block 425, one or more curved lines may be identified to be processed (cut) by the liquid jet cutter on the substrate. In block 430, the mechanical cutter may be displaced to cut or score the substrate along the identified straight lines. In block 435, the liquid jet cutter may be displaced to cut the substrate along the identified curved lines.

It will be appreciated that examples described herein may be realized in the form of hardware or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disc or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine readable storage storing such a program. Still further, some examples may be conveyed electronically via any medium such as a communication signal carried over a wired or wireless connection.

All of the features disclosed in this specification (including any accompanying claims, abstract and drawings), and/or all of the operations of any method or process so disclosed, may be combined in any combination, except combinations where at least some of such features and/or operations are mutually exclusive.

Each feature disclosed in this specification (including any accompanying claims, abstract and drawings), may be replaced by alternative features serving the same, equivalent or similar purpose, unless expressly stated otherwise.

Although a number of particular implementations and examples have been disclosed herein, further variants and modifications of the disclosed devices and methods are possible. As such, representative examples of the present disclosure have utility over a wide range of applications, and the above discussion is not intended and should not be construed to be limiting, but is offered as an illustrative discussion of aspects of the disclosure. Many variations are possible within the spirit and scope of the disclosure, which is intended to be defined by the following claims—and their equivalents—in which all terms are meant in their broadest reasonable sense unless otherwise indicated.

1. A device to process a substrate comprising:
a contact processing module;
a non-contact processing module; and
a controller, to
identify straight and curved lines to be processed on the substrate,
displace the contact processing module relative to the substrate to process the straight lines,
displace the non-contact processing module relative to the substrate to process the curved lines.

2. The device according to claim 1, comprising
a processing surface to support the substrate;
a first holding unit for holding and moving the contact processing module at a distance from a surface of the substrate;
a second holding unit for holding and moving the non-contact processing module at a distance from a surface of the substrate.

3. The device according to claim 2, wherein each of the first and second holding units comprises:
a bridge including a slider for holding the respective processing module, wherein the processing module is slidable along the slider of the bridge in a first direction at a predefined distance from the surface of the substrate.

4. The device according to claim 2, wherein the holding units are adjustable to increase or decrease the distance between the processing modules and the substrate, respectively.

5. The device according to claim 1, comprising a plurality of contact processing modules and/or a plurality of non-contact processing modules.

6. The device according to claim 1, wherein the contact processing module comprises at least a wheel type cutter.

7. The device according to claim 1, wherein the non-contact processing module comprises at least one liquid nitrogen cutter.

8. The device according to claim 1, to process a substrate comprising at least one sheet of paper, cardboard or carton and wherein processing comprises cutting or scoring of the substrate.

9. A substrate hybrid processing system comprising:
a platform to support the substrate;
a contact processing cutter, displaceable above the platform, to cut or score straight lines on the substrate; and
a non-contact processing cutter, displaceable above the platform and arranged in parallel to the “contact” substrate processing cutter to cut curved lines on the substrate.

10. The substrate hybrid processing system according to claim 9, wherein the platform comprises a mechanical belt to displace the substrate below the processing cutters.

11. A method of processing a substrate, comprising:
arranging the substrate on a processing surface;
providing a contact cutter above a first portion of the substrate;
providing a non-contact cutter above a second portion of the substrate;
identifying one or more straight lines to cut or score on the substrate;
identifying one or more curved lines to cut on the substrate;
relatively displacing the contact cutter with respect to the processing surface to cut or score the substrate along the identified straight lines; and
relatively displacing the non-contact cutter with respect to the processing surface to cut the substrate along the identified curved lines.

12. The method according to claim 11, wherein displacing the contact cutter is performed in parallel to displacing the liquid jet cutter.

13. The method according to claim 11, wherein relatively displacing the contact cutter is performed before or after relatively displacing the non-contact cutter.

14. The method according to claim 11, wherein relatively displacing the contact cutter and/or the non-contact cutter comprises relatively displacing in two directions.

15. The method according to claim 11, comprising relatively displacing a plurality of contact cutters and/or a plurality of non-contact cutters.
